(19) United States
(12) Patent Application Publication
(10) Pub. No.: US 2011/0072903 A1
(43) Pub. Date: Mar. 31, 2011

(54) PORTABLE DEVICE FOR ASSESSING WARP STABILITY

(75) Inventor: Stanley L. Floyd, Enumclaw, WA (US)

(73) Assignee: Weyerhaeuser NR Company, Fedral Way, WA (US)

(21) Appl. No.: 12/570,315

(22) Filed: Sep. 30, 2009

(51) Int. Cl. G01N 29/07

(52) U.S. Cl. 73/598

(57) ABSTRACT

The present disclosure includes a portable device for assessing warp stability of a wood element having two or more planar surfaces. In some embodiments, the portable device includes a sensor housing positioned adjacent to the wood element, a first sensor group configured to sense one or more first measurements on a first planar surface, and a second sensor group configured to sense one or more second measurements on a second planar surface. The first measurements and the second measurements are inputted into an algorithm for assessing warp stability of the wood element. In some embodiments the model is based at least partially on measurement of compression wave velocity. In some embodiments, the model is based on the tracheid effect.

### TECHNICAL FIELD

The present disclosure is directed generally to portable devices for assessing warp stability of a wood element.

### BACKGROUND

A major source of raw material for the wood processing industry is supplied by trees grown on intensively managed plantations or “tree farms”. Over the years, nurseries producing seed for plantation trees have used intensive genetic selection to improve such heritable traits as rapid growth, straightness of stem, reduced limb diameter, and other desirable characteristics, and silvicultural innovations, such as better regeneration, fertilization, vegetation control, thinning, and pruning, have significantly increased the growth rate and visual quality and greatly shortened the rotation age of plantations. Consequently, depending on the species and growth locale, plantation trees for saw logs are usually harvested on a 20-50 year growth cycle, with various pine species being typically harvested 20-30 years after planting.

The raw material supplied to mills from plantations has characteristics that have been shown to be more variable due to the plantation's shortened growth cycle, as will now be explained. Most conifer species produce wood having so-called juvenile characteristics during the first 10-20 years of their growth. This juvenile wood is characterized by thinner cell (tracheid) walls, a higher microfibril angle in the tracheid walls, lower specific gravity, increased lignin, increased hemicellulose, and less cellulose than those of mature trees. High microfibril angle, low density, and varying quantities of chemicals in juvenile wood are the fundamental properties that impair the quality (i.e., stiffness and dimensional stability) of the wood products. After about 12-20 years of growth, density begins to increase as wood is laid down at greater distances from the pith and the microfibril angle begins to decrease until the wood has acquired “adult” properties. Under normal conditions during the wood's “mature stage”, density, microfibril angle, and chemicals of the wood remain essentially constant during the remaining years of the tree's growth. Therefore, logs harvested from the short-rotation plantations may be prone to both warp and lower stiffness.

In the North America, most softwood dimension lumber is visually graded for a variety of attributes that affect its appearance and structural properties. These attributes include knots, wane, dimension (thickness, width, and length), decay, splits and checks, slope-of-grain, and straightness (warp). Strict quality control practices overseen by third party grading agencies are in place to ensure that all lumber is “on-grade” at the point the grade is assigned. Unfortunately, the straightness of a piece is not static and can change after the piece is graded. Additional warp can develop after the piece is in the distribution channel or after it is put into service. Typical moisture content of fresh kiln dried softwood dimension lumber averages near 15% but ranges from 6% to 19%. This lumber will eventually equilibrate to a moisture ranging from 3% to 19% depending on time of year, geography and whether the application is interior or exterior. The moisture change that occurs within an individual piece of lumber can result in a change in its straightness. Any piece of lumber is prone to develop additional “in-service” warp if its shrinkage properties are not uniform and it changes moisture after the original grade was assigned. This condition is not detectable with traditional visual grading methods. Therefore, there is a need in the industry to have testing techniques that predict warp stability of lumber and suitability for use in the environment that it is exposed to.

To address such an ongoing need of the commercial wood products industry, non-destructive testing devices and methods have been developed that utilize various techniques for non-destructive testing of wood properties, such as warp propensity, stiffness, and degree of decay. Several of these devices and methods are disclosed in U.S. Pat. No. 6,347,551, U.S. Pat. No. 6,276,209, U.S. Pat. No. 6,026,689, U.S. Pat. No. 6,305,224, U.S. Pat. No. 6,598,477, U.S. Pat. No. 6,871,545, U.S. Pat. No. 7,266,461, U.S. Pat. No. 7,286,956, and U.S. Patent Application Publication 2008/0243424 A1, all of which are hereby incorporated by reference.

While these prior art devices and methods are adequate in testing wood properties, the devices and methods are not without their deficiencies or disadvantages. For instance, the prior art devices currently available commercially do not include, in one packaged device, all of the sensors necessary to perform some methods of non-destructive testing. Thus, there is a need to develop a portable device which is capable of taking specific combinations of measurements useful in assessing warp stability of a wood element.

### SUMMARY

The following summary is provided for the benefit of the reader only and is not intended to limit in any way the invention as set forth by the claims. The present disclosure is directed generally towards portable devices for assessing warp stability of a wood element.

In one embodiment, the present disclosure includes a portable device for assessing warp stability of a wood element having two or more planar surfaces. The portable device includes a sensor housing positioned adjacent to the wood element, a first sensor group configured to sense one or more first measurements on a first planar surface, and a second sensor group configured to sense one or more second measurements on a second planar surface. The first measurements and the second measurements are inputted into an algorithm for assessing warp stability of the wood element.

In another embodiment, the portable device includes a sensor housing positioned adjacent to the wood element and one or more pairs of compression wave transducers. Each of the transducer pairs includes a sender configured to generate a compression wave of energy from a first location and a receiver configured to detect a signal indicating arrival of the compression wave at a second location, the first location and the second location being separated by a known distance. The portable device may also include a signal processing unit configured to process the signal to determine a time of flight of the compression wave and one or more sensors configured to measure initial warp of the wood element.

In yet another embodiment, the portable device includes a sensor housing positioned adjacent to the wood element, one or more first light sources configured to illuminate a first planar surface of the wood element, one or more first sensors configured to measure a first pattern of diffuse reflection from the first planar surface, one or more second light sources configured to illuminate a second planar surface of the wood element, and one or more second sensors configured to measure a second pattern of diffuse reflection from the second planar surface. The device may further include a data display and processing unit, the data display and processing unit being configured to assess warp stability of the wood element based at least partially on the first pattern of diffuse reflection and the second pattern of diffuse reflection.

### BRIEF DESCRIPTION OF THE DRAWINGS

The present disclosure is better understood by reading the following description of non-limitative embodiments with reference to the attached drawings wherein like parts of each of the figures are identified by the same reference characters, and are briefly described as follows:

FIGS. 1-4 show examples of various types of warp that can occur in a wood element;

FIG. 5 is an isometric view of an embodiment of a portable device for assessing warp stability according to the disclosure;

FIG. 6 is a schematic view of an embodiment of compression wave generator/detector pairs according to the disclosure;

FIG. 7 is a side view of an embodiment of a portable device for assessing warp stability according to the disclosure;

FIG. 8 is a side view of an enlarged section of the portable device for assessing warp stability shown in FIG. 7;

FIG. 9 is an isometric view of an embodiment of a portable device for assessing warp stability according to the disclosure; and

FIG. 10 is a schematic view of an embodiment of a portable device for assessing warp stability according to the disclosure in operation.

### DETAILED DESCRIPTION

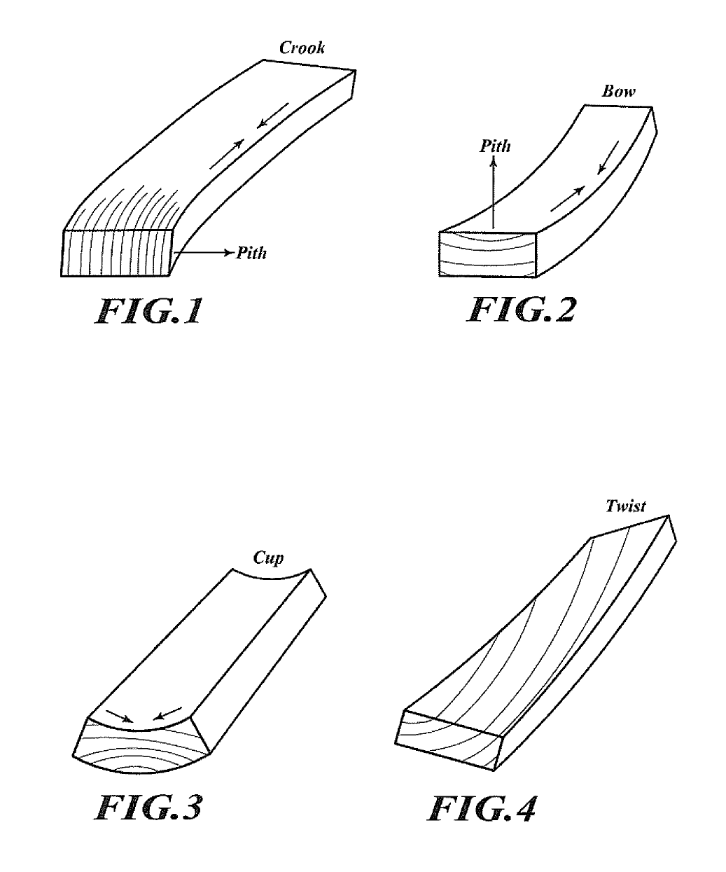

The present disclosure describes portable devices for assessing warp stability of a wood element. Certain specific details are set forth in the following description and FIGS. 1-10 to provide a thorough understanding of various embodiments of the disclosure. Well-known structures, systems, and methods often associated with such systems have not been shown or described in details to avoid unnecessarily obscuring the description of various embodiments of the disclosure. In addition, those of ordinary skill in the relevant art will understand that additional embodiments of the disclosure may be practiced without several of the details described below.

In this disclosure, the term “wood” is used to refer to any cellulose-based material produced from trees, shrubs, bushes, grasses or the like. The disclosure is not intended to be limited to a particular species or type of wood. The term “log” is used to refer to the stem of standing trees, felled and delimbed trees, and felled trees cut into appropriate lengths for processing in a wood product manufacturing facility. The term “wood element” is used to refer to a product manufactured from logs such as lumber (e.g., boards, dimension lumber, headers and beams, timbers, mouldings and other appearance products; laminated, finger jointed, or semi-finished lumber such as flitches and cants); veneer products; or wood strand products (e.g., oriented strand board, oriented strand lumber, laminated strand lumber, parallel strand lumber, and other similar composites). The term “surface profiling device' is used to mean a device configured to measure shape of a wood element or equivalent, including both single-point and multi-point locating devices.

Warp typically occurs in four orientations, which can be referred to as crook, bow, cup, and twist. Referring to FIG. 1, crook refers to in-plane, edgewise curvature of wood relative to a longitudinal axis. Referring to FIG. 2, bow refers to in-plane face wise curvature relative to a longitudinal axis. Crook and bow are closely related and differ primarily according to the planar surface used to define the warp. Cup, on the other hand, refers to in-plane, face wise curvature of wood relative to a lateral axis as shown in FIG. 3. Twist, another type of warp, refers to a rotational instability about an axis of wood (usually the longitudinal axis) as shown in FIG. 4. Twist is associated with varying grain angle pattern as described in U.S. Pat. No. 6,293,152, which is hereby incorporated by reference. Other forms of warp are influenced by a myriad of factors as described in U.S. Pat. Nos. 6,305,224, 6,308,571 and 7,017,413, which are hereby incorporated by reference.

Portable devices according to embodiments of the disclosure include sensor groups configured to take measurements useful in predicting warp stability of wood elements. Some embodiments of the disclosure assess warp using, for example, methods described in U.S. Pat. No. 7,286,956 and U.S. Patent Application Publication 2008/0243424 A1. These methods may include measurement of compression wave velocity in the wood element and measurement of initial warp. Other embodiments of the disclosure are directed toward methods for assessing warp according to the “tracheid effect,” which is described, for example in U.S. Pat. No. 6,598,477 and U.S. Pat. No. 7,286,956. Embodiments of portable devices according to the disclosure may also be used with other methods for assessing warp stability based on the same or similar combinations of measurements.

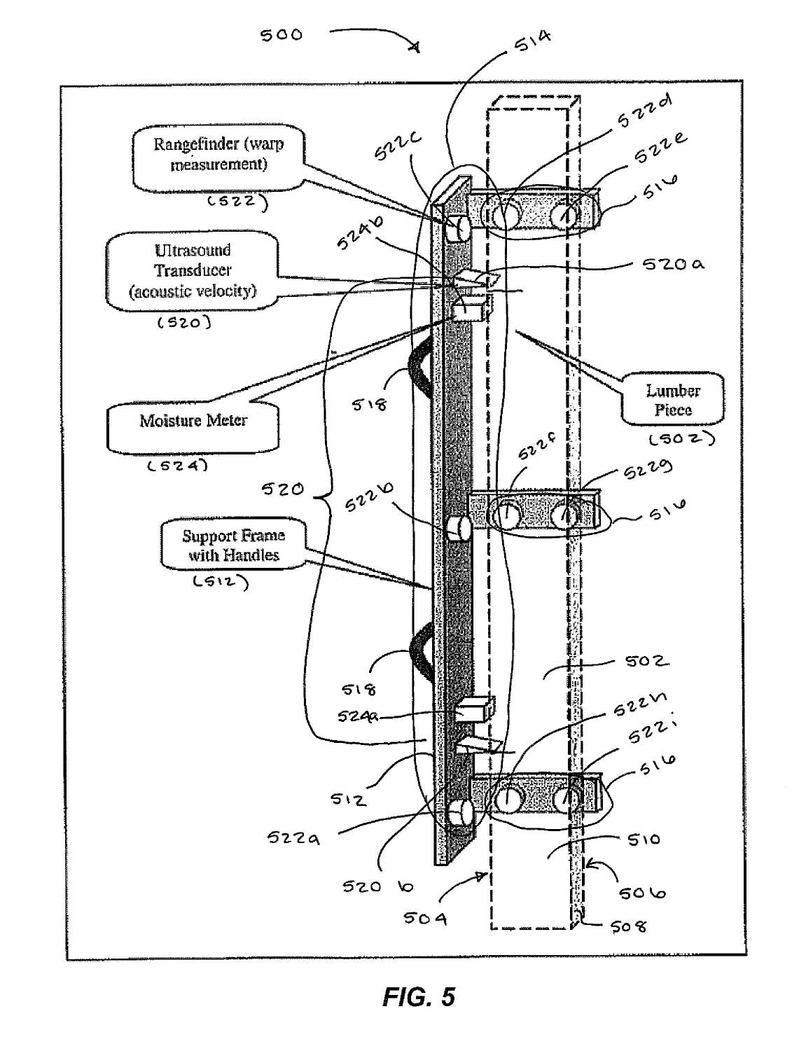

FIG. 5 illustrates an example of one embodiment of a portable device 500 for assessing warp stability according to embodiments of the disclosure. The portable device 500 is shown positioned adjacent to a wood element 502. The wood element 502 shown has four planar surfaces: a first planar surface 504, a second planar surface 506, a third planar surface 508, and a fourth planar surface 510. Embodiments according to the disclosure may be used with any wood element having at least one substantially planar surface.

The portable device 500 includes a sensor housing 512 positioned adjacent to the wood element 502. The sensor housing 512 may be made from any material known to those of ordinary skill in the art and constructed in any manner suitable to position the sensors as described. In some embodiments, the portable device 500 includes a first sensor group 514 configured to sense one or more first measurements on the first planar surface 504, and a second sensor group 516 configured to sense one or more second measurements on the second planar surface 506. The first measurements and the second measurements are inputted into an algorithm for assessing warp stability of the wood element. The portable device 500 may optionally include one or more handles 518 to help an operator grip and maneuver the device.

In some embodiments, the algorithm for assessing warp stability is based at least partially on measurements of compression wave velocity and initial warp of the wood element. Examples of embodiments of such devices are illustrated in FIGS. 5, 6, 7, and 8. Compression wave velocity may be measured, for example, by any type of compression wave transducer pairs. FIG. 5 shows one pair of compression wave transducer pairs 520; however, more than one pair may be used in embodiments according to the disclosure. In the embodiment shown, the compression wave transducer pair 520 comprises an ultrasonic generator or sender 520a and an ultrasonic receiver 520b; however any type of compression wave velocity measurement device know to a person of ordinary skill in the art may be used.

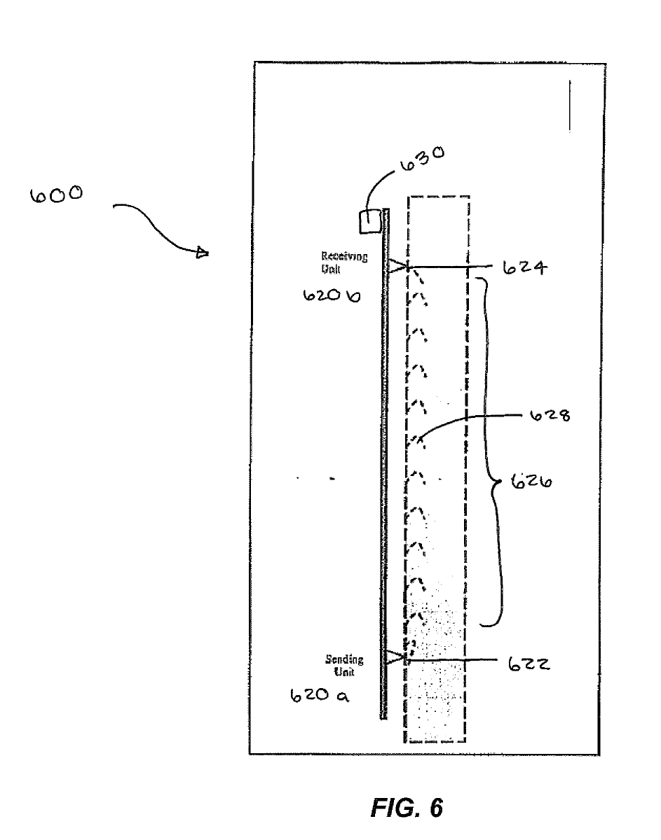

FIG. 6 is an example of a compression wave generator/detector pair 600 according to embodiments of the disclosure. In FIG. 6, a compression wave sender 620a is shown positioned at a first location 622 and a compression wave receiver 620b is shown positioned at a second location 624. The first location 622 is separated from the second location 624 by a known distance 626. The compression wave source 620a generates a pulse of compression wave energy (shown as 628) from the first location 622, and the compression wave receiver 620b detects a signal which indicates arrival of the pulse of compression wave energy 628 at the second location 624. A signal processing unit 630 processes the signal to determine a time of flight of the pulse of compression wave energy 628. The compression wave source 620a may be an impulse derived from a variety of methods involving mechanical impact, explosion, electromagnetic speakers and/or piezoelectric transducers. Frequency content of the compression wave may range from within the range of human hearing to ultrasonic.

In addition to the compression wave velocity measurements mentioned above, embodiments of the disclosure may also include one or more sensors configured to measure initial warp of the wood element. In this disclosure, such devices are referred to as surface profiling devices. The first sensor group 514 may include one or more surface profiling devices and the second sensor group 516 may include also include one or more sensor profiling devices. In FIG. 5, the portable device 500 includes nine surface profiling devices: a first surface profiling device 522a, a second surface profiling device 522b, a third surface profiling device 522c, a fourth surface profiling device 522d, a fifth surface profiling device 522e, a sixth surface profiling device 522f, a seventh surface profiling device 522g, and an eighth surface profiling device 522h, and a ninth surface profiling device 522i. Surface profiling devices suitable for use according to this disclosure include rangefinders or any other technology that is capable of measuring the location of the wood element 502 over the length of the portable device 500. Surface profiling devices according to the disclosure may be both single-point locating devices (e.g., rangefinders, calipers) and/or multi-point locating devices (e.g., lasers, ultrasonics).

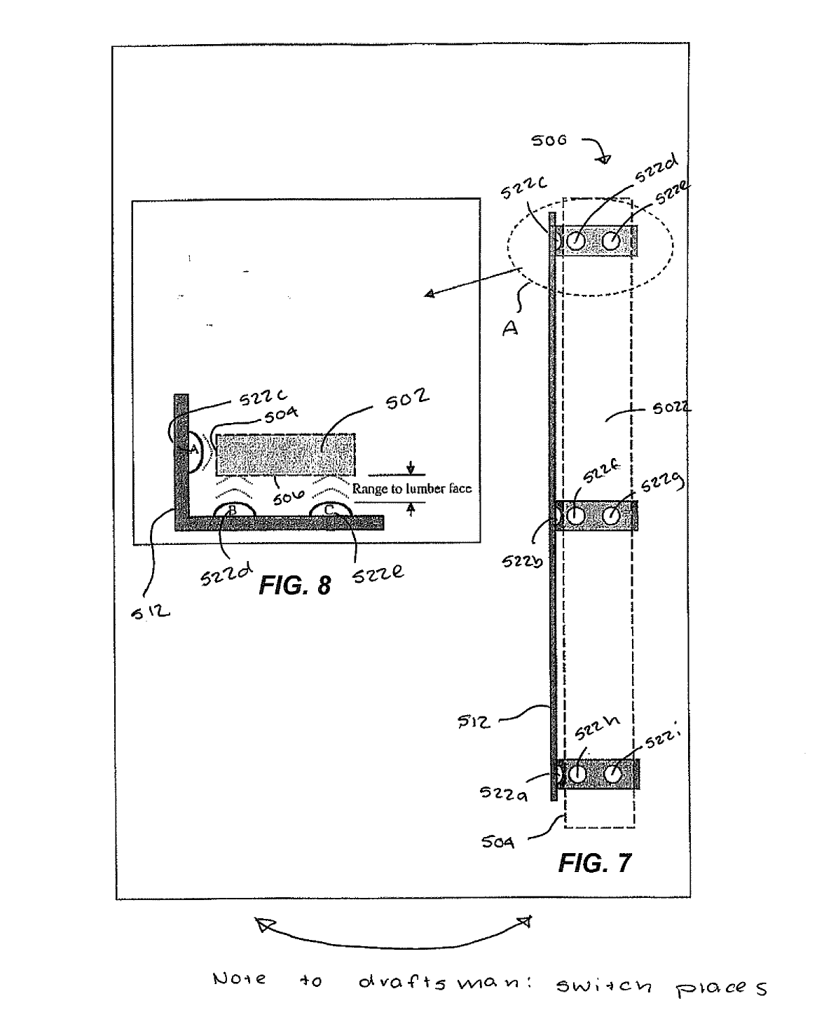

FIGS. 7 and 8 are depictions of the portable device 500 shown in FIG. 5, which help to illustrate the operation of the surface profiling devices according to embodiments of the disclosure. FIG. 7 is a side view of the portable device 500 indicating Region A which is shown enlarged in FIG. 8. In FIG. 8, the third surface profiling device 522c measures the location of a section of the wood element 502 on the first planar surface 504. This measurement may be useful in determining initial crook of the wood element 502. The fourth surface profiling device 522d and the fifth surface profiling device 522e measure the locations of sections of the wood element 502 on the second planar surface 506. Data from the fourth surface profiling device 522d and the fifth surface profiling device 522e may be useful in determining initial bow of the wood element 502. The difference between the data from the fourth surface profiling device 522d and the fifth surface profiling device 522e may be used to determine twist of the wood element 502.

In FIGS. 7 and 8, the third surface profiling device 522c, the fourth surface profiling device 522d, and the fifth surface profiling device 522e represent a single set of surface profiling devices. In embodiments according to the disclosure, the portable device 500 may include one or more individual sets of surface profiling devices. In embodiments where multiple sets of surface profiling devices are used, the sets may be distributed over the length of the portion of the wood element 502 being analyzed by the portable device 500. In some embodiments, the surface profiling devices are each positioned in a vicinity of a relatively wane-free section of the wood element 502.

Referring back to FIG. 5, the portable device 500 may further include one or more devices for measuring initial moisture of the wood element 502. In FIG. 5, these are depicted as a first moisture meter 524a and a second moisture meter 524; however other devices known to those of ordinary skill in the art may be used. Moisture meters 524a and 524b may include resistance probes, dielectrics, or any other device used for measuring moisture that is known to a person of ordinary skill in the art. In embodiments according to the disclosure, warp stability of the wood element 502 may be assessed based at least partially on the time of flight of the compression wave pulse and the initial warp of the wood element 502. Algorithms suitable for use with embodiments of the disclosure are described, for example, in U.S. Pat. No. 7,286,956 and U.S. Patent Application Publication 2008/0243424 A1. In addition, other algorithms known to those of ordinary skill in the art may be used.

In some embodiments, the model for assessing warp stability is based at least partially on a phenomenon known as the “tracheid effect.” As described in U.S. Pat. No. 7,286,956, when a wood surface is illuminated by a point or line source, the patterns of diffuse reflection are influenced by the physical properties of the wood. Metrics or parameters calculated from these patterns may be used to estimate physical properties of the wood such as shrinkage and grain angles properties.

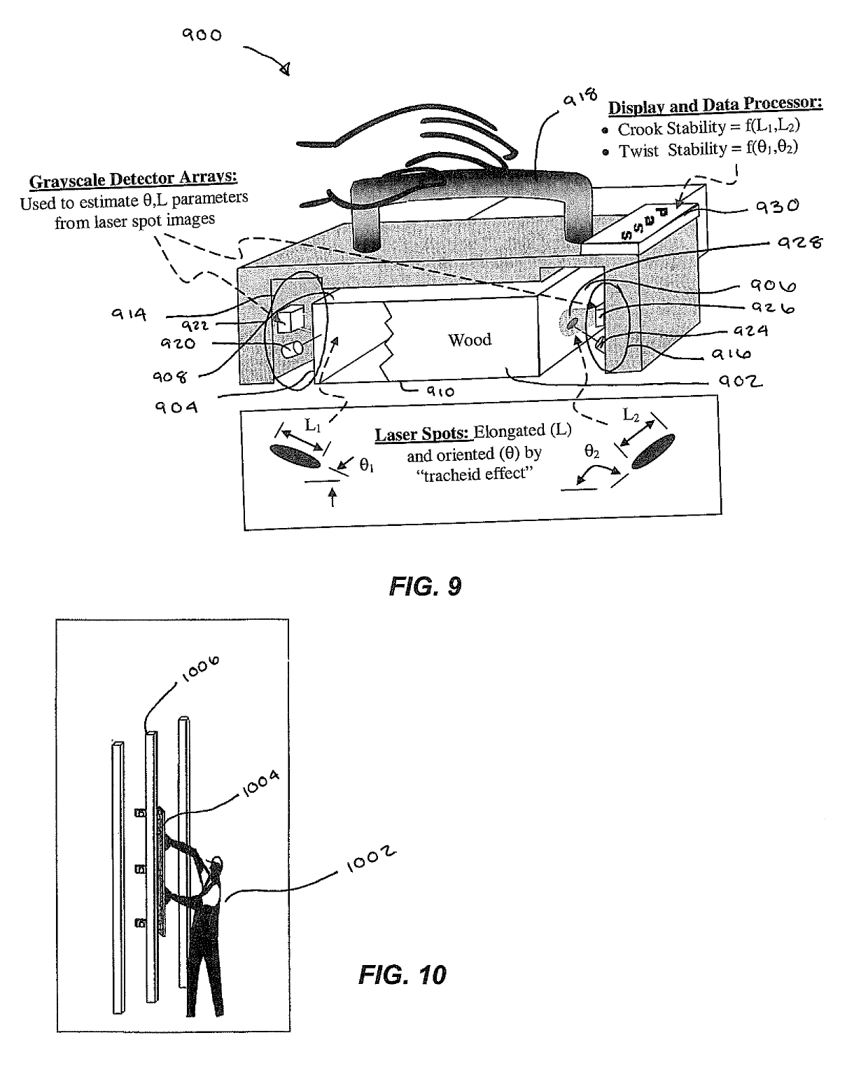

Examples of embodiments of devices utilizing the tracheid effect are illustrated in FIG. 9. In FIG. 9, a portable device 900 is shown positioned adjacent to a wood element 902. The wood element 902 shown has four planar surfaces: a first planar surface 904, a second planar surface 906, a third planar surface 908, and a fourth planar surface 910. Embodiments in the disclosure may be used with any wood element having at least one substantially planar surface.

The portable device 900 shown includes a sensor housing 912 positioned adjacent to the wood element 902. The sensor housing 912 may be made from any material known to those of ordinary skill in the art and constructed in any manner suitable to position the sensors as described. In some embodiments, the portable device 900 includes a first sensor group 914 configured to sense one or more first measurements on the first planar surface 904, and a second sensor group 916 configured to sense one or more second measurements on the second planar surface 906. The first measurements and the second measurements are inputted into an algorithm for assessing warp stability of the wood element. The portable device 900 may optionally include one or more handles 918 to help an operator grip and maneuver the device.

In some embodiments, the first sensor group 914 includes one or more first light sources configured to illuminate the first planar surface 904 of the wood element 902 and one or more first sensors configured to measure a first pattern of diffuse reflection from the first planar surface 904. The second sensor group 916 includes one or more second light sources configured to illuminate the second planar surface 906 of the wood element 902 and one or more second sensors configured to measure a second pattern of diffuse reflection from the second planar surface 906. In FIG. 9, a first light source 920 and a second light source 924 are shown. The first light source 920 and the second light source 924 may be laser spot generators or other devices known in the art.

A variety of sensors may be used to measure patterns of diffuse reflection on the wood element 902. FIG. 9 shows, for example, a first sensor 922 and a second sensor 926. The first sensor 922 measures a pattern of diffuse reflection on the first planar surface 904. The second sensor 926 measures a pattern of diffuse reflection on the second planar surface 906. The first sensor 922 and the second sensor 926 may be gray scale detectors, gray scale detector arrays, or any other diffuse reflection measurement device known to those of ordinary skill in the art. As shown in FIG. 9, light sources according to the disclosure may create an ellipse pattern 928 on the wood element 902. Parameters such as the ellipse ratio (length of ellipse divided by width of ellipse) and ellipse angle (angle of long axis of the ellipse relative to the lengthwise axis of the wood element) may be calculated. The surface grain angle may be estimated from the ellipse angle as described, for example, in U.S. Pat. No. 7,286,956.

Embodiments of the disclosure may further include a data display and processing unit 930 as shown in FIG. 9. The data display and processing unit 930 may be configured to assess warp stability of the wood element based at least partially on the first pattern of diffuse reflection and the second pattern of diffuse reflection. For example, the crook stability of the wood element 902 may be predicted as a function of the ellipse ratio. As another example, the twist stability of the wood element 902 may be predicted as a function of the ellipse angle. This information may optionally be displayed to an operator on the data display and processing unit 930.

FIG. 10 is a schematic view of an embodiment of an operator 1002 using a portable device 1004 for assessing warp stability. In FIG. 10, the portable device 1004 is handheld and the operator 1002 holds it adjacent to the wood element 1006. In the embodiment shown, the wood element 1006 is a piece of lumber; however, embodiments according to the disclosure may be used with other types of wood elements. In FIG. 10, the operator 1002 is shown holding a device which is similar to the embodiment shown in FIG. 5; however, other embodiments according to the disclosure may be used in a similar manner. The operator 1002 may be a worker in a manufacturing facility or a construction site or any other location where assessing the warp stability of a wood element may be useful.

From the foregoing, it will be appreciated that the specific embodiments of the disclosure have been described herein for purposes of illustration, but that various modifications may be made without deviating from the disclosure. For example, specific types of sensors described may be replaced with sensors that are known or would be obvious to one of ordinary skill in the art. In addition, various modifications of the arrangement of the sensors may also be made.

Aspects of the disclosure described in the context of particular embodiments may be combined or eliminated in other embodiments. For example, aspects of the embodiments using an algorithm based on compression wave velocity may be combined with aspects of embodiments using an algorithm based on tracheid effect measurement. Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

I/We claim:

1. A portable device for assessing warp stability of a wood element having two or more planar surfaces, the portable device comprising:
a sensor housing positioned adjacent to the wood element;
a first sensor group configured to sense one or more first measurements on a first planar surface; and
a second sensor group configured to sense one or more second measurements on a second planar surface;
wherein the one or more first measurements and the one or more second measurements are inputted into an algorithm for assessing warp stability of the wood element.

2. The portable device of claim 1, further comprising one or more handles attached to the sensor housing.

3. The portable device of claim 1 wherein the one or more first measurements comprise measurements of compression wave velocity and the one or more second measurements comprise initial warp measurements.

4. The portable device of claim 3 wherein the first sensor group is arranged in a first plane and the second sensor group is arranged in a second plane, the first plane being substantially perpendicular to the second plane.

5. The portable device of claim 3, further comprising one or more third sensor groups configured to sense one or more third measurements;
wherein the one or more third measurements comprise initial moisture measurements; and
wherein the one or more third measurements are inputted into the algorithm for assessing warp stability of the wood element.

6. The portable device of claim 3 wherein the first measurements comprise one or more compression wave generator/detector pairs.

7. The portable device of claim 3 wherein the second measurements comprises one or more surface profiling devices.

8. The portable device of claim 6 wherein the one or more compression wave generator/detector pairs each comprise an ultrasonic transducer and an ultrasonic receiver.

9. The portable device of claim 6 wherein the one or more compression wave generator/detector pairs each comprise a transducer and a receiver, the transducer being configured to send a signal having a frequency within range of human hearing, and the receiver being configured to receive the signal.

10. The portable device of claim 1 wherein the one or more first measurements comprise patterns of diffuse reflection on the first planar surface and the one or more second measurements comprise patterns of diffuse reflection on the second planar surface.

11. The portable device of claim 10 wherein the first sensor group is arranged in a first plane and the second sensor group is arranged in a second plane, the first plane being substantially parallel to the second plane.

12. The portable device of claim 9 wherein the first sensor group comprises:
one or more first projected light sources; and
one or more first grayscale detectors; and
wherein the second sensor group comprises:
one or more second projected light sources; and
one or more second grayscale detectors.

13. A portable device for assessing warp stability of a wood element, the portable device comprising:
a sensor housing positioned adjacent to the wood element;
one or more pairs of compression wave transducers, each of the one or more pairs of compression wave transducers comprising:
a sender configured to generate a pulse of compression wave energy from a first location; and
a receiver configured to detect a signal indicating arrival of the pulse of compression wave energy at a second location, the first location and the second location being separated by a known distance;
a signal processing unit configured to process the signal to determine a time of flight of the pulse of compression wave energy; and
one or more sensors configured to measure initial warp of the wood element;
wherein assessment of the warp stability of the wood element is based at least partially on the time of flight of the pulse of compression wave energy and the initial warp of the wood element.

14. The portable device of claim 13, further comprising one or more moisture meters configured to measure initial moisture content of the wood element and wherein assessment of the warp stability of the wood element is also based at least partially on the initial moisture content.

15. The portable device of claim 13 wherein the one or more sensors configured to measure initial warp of the wood element comprise:
one or more first surface profiling devices positioned adjacent to a first planar surface of the wood element;
one or more second surface profiling devices positioned adjacent to a second planar surface of the wood element, the second planar surface being substantially perpendicular to the first planar surface; and
wherein the one or more first surface profiling devices measure bow and twist and the one or more second surface profiling devices measure crook

16. The portable device of claim 15 wherein the one or more first surface profiling devices and the one or more second surface profiling devices are each positioned in a vicinity of a relatively wane-free section of the wood element.

17. A portable device for assessing warp stability of a wood element, the portable device comprising:
a sensor housing positioned adjacent to the wood element;
one or more first light sources configured to illuminate a first planar surface of the wood element;
one or more first sensors configured to measure a first pattern of diffuse reflection from the first planar surface;
one or more second light sources configured to illuminate a second planar surface of the wood element;
one or more second sensors configured to measure a second pattern of diffuse reflection from the second planar surface;
a data display and processing unit, the data display and processing unit being configured to assess warp stability of the wood element based at least partially on the first pattern of diffuse reflection and the second pattern of diffuse reflection.

18. The portable device of claim 17 wherein the one or more first sensors and the one or more second sensors are grayscale detector arrays.

19. The portable device of claim 17 wherein the one or more first light sources and the one or more second light sources each comprise one or more laser spots.

20. The portable device of claim 17 wherein the first planar surface is substantially parallel to the second planar surface.
